(19) United States
(12) Patent Application Publication
(10) Pub. No.: US 2005/0119044 A1
(43) Pub. Date: Jun. 2, 2005

(54) Jackpot system

(75) Inventors: Jason Lim, Botany NSW (AU); Osamu Yoshimi, Botany (AU); Toshiaki Shimizu, Botany (AU)

Correspondence Address: LADAS & PARRY, 26 WEST 61ST STREET, NEW YORK, NY, 10023, US

(73) Assignee: KONAMI AUTRALIA PTY LTD, Botany NSW (AU)

(21) Appl. No.: 10/974,546

(22) Filed: Oct. 27, 2004

(30) Foreign Application Priority Data
Oct. 31, 2003 (AU) 2003905989

(51) Int. Cl. G06F 17/00

(52) U.S. Cl. 463/25

(57) ABSTRACT

A method of play on an electronic gaming machine wherein at least one predefined outcome of a base game played on said gaming machine triggers the winning of at least one jackpot prize from a range of potential jackpot prizes; said range of potential jackpot prizes being non-monetary prizes.

The present invention relates to a systems of stand-alone and interlinked gaming machines or consoles of the type generally referred to as slot machines, fruit machines or poker machines, and in particular to a game play control system for such machines having a multiple jackpot management means where the jackpots conferred are of a non-monetary nature.

### BACKGROUND

Gaming or poker machines have become a major source of amusement and diversion in such places as clubs, hotels and casinos in many parts of the world.

Traditionally such machines were mechanical devices where a number of reels marked with a plurality of numbers or symbols could be made to spin randomly by the application of some mechanical input. If the subsequent patterns of numbers or symbols displayed on the reels, when these returned to a rest state, corresponded to predetermined patterns, the machine would provide a prize or payout. Generally such gaming machines have come to be regulated by government authorities as to their number and in the manner in which the machines must return a percentage of the monetary turnover to the players.

The introduction of electronics, computers and electronic graphical displays, has allowed a continual increase in the complexity and variations of gaming machines and games while maintaining the basic concept of the traditional machine.

Machines and games that offer novel and stimulating variations on the basic game theme and environment are eagerly sought by the gaming industry and there is consequently intense competition between machine manufacturers to innovate.

Nevertheless the repetitive playing of even modern gaming machines can lead to boredom of the players with a consequent under-utilization of machines and increase in player dissatisfaction.

It is an object of the present invention to offer a variation which may ameliorate the above disadvantages.

### BRIEF DESCRIPTION OF INVENTION

Accordingly, in one broad form of the invention there is provided a method of play on an electronic gaming machine wherein at least one predefined outcome of a base game played on said gaming machine triggers the winning of at least one jackpot prize from a range of potential jackpot prizes; said range of potential jackpot prizes being non-monetary prizes.

Preferably said non-monetary prizes are bonus games.

Preferably said non-monetary prizes are items of perceived value.

Preferably said non-monetary prizes are combinations of bonus games and at least one item of perceived value.

Preferably indicia relating to said potential jackpot prizes is displayed on a segment of a single graphic display screen of said electronic gaming machine.

Preferably indicia relating to said potential jackpot prizes is displayed on a secondary graphic display screen of said electronic gaming machine.

Preferably said graphic display screen is a cathode ray tube.

Preferably said graphic display screen is a liquid crystal display.

Preferably said graphic display screen is a plasma screen.

Preferably said graphic display screen is that of a back projection system.

Preferably said indicia indicates a number of bonus games comprising said at least one jackpot prize.

Preferably said indicia indicates at least one of said items of perceived value.

Preferably said at least one jackpot prize is one of at least three levels of jackpot prizes.

Preferably said at least three levels of jackpot prizes comprises a number of said bonus games.

Preferably said at least three levels of jackpot prizes comprises a said item of perceived value.

Preferably said number of bonus games increases progressively between a minimum number of said bonus games for a lowest level of said at least three levels of jackpot prizes to a maximum number of said bonus games for a highest level of said at least three levels of jackpot prizes.

Preferably said item of perceived value increases from an item of minimum value for a lowest level of said at least three levels of jackpot prizes to an item of maximum value for a highest level of said at least three levels of jackpot prizes.

Preferably awarding of a level of said at least three levels of jackpot prizes is determined by said at least one predefined outcome of said base game.

Preferably said electronic gaming machine is a stand-alone electronic gaming machine.

Preferably said electronic gaming machine is one of a plurality of electronic gaming machines.

Preferably each one of said plurality of electronic gaming machines is linked to a site controller.

Preferably said site controller is adapted to the recording of turnover on each one of said plurality of electronic gaming machines as progressive amounts.

Preferably said site controller transmits updated values of said progressive amounts to a progressive controller module of each one of said plurality of electronic gaming machines for determination of said at least one jackpot prize.

Preferably a play of said base game on one electronic gaming machine of said plurality of electronic gaming machines in which an outcome of said play coincides with one of said at least one predefined outcome causes a hit event signal to be transmitted to a progressive controller module of said one electronic gaming machine.

Preferably said progressive controller module transmits a hit event notification signal to said site controller.

Preferably said progressive controller module transmits a hit animation command to a graphic display controller module of said one electronic gaming machine.

Preferably each graphic display controller module of each said graphic display screen of said plurality of electronic gaming machines is in communication with all other graphic display controller modules.

Preferably said hit animation command is transmitted to all said graphic display controller modules.

Preferably said animation command is adapted to the display of indicia spread over at least two graphic display screens of said plurality of electronic gaming machines.

Preferably said hit event received by said site controller triggers transmission of a hit acknowledgement signal to said progressive controller module; said signal including current monetary value of said progressive amounts appropriate to said hit event.

Preferably said progressive controller module converts said monetary value into a corresponding number of bonus games comprising said at least one jackpot prize.

Preferably said progressive controller module converts said monetary value into a reference for a corresponding item of perceived value.

Preferably said number of bonus games is displayed on said graphic display screen of

Preferably imagery of said corresponding item of perceived value is displayed on said graphic display screen.

In a further broad form of the invention there is provided apparatus for the playing of a games of chance wherein the outcome of a base game played on said apparatus triggers the winning of at least one jackpot prize from a range of potential jackpot prizes; said range of potential jackpot prizes being non-monetary prizes.

Preferably said non-monetary prizes are bonus games.

Preferably said non-monetary prizes are items of perceived value.

Preferably said non-monetary prizes are combinations of bonus games and at least one item of perceived value.

Preferably said apparatus includes at least one electronic gaming machine.

Preferably said at least one electronic gaming machine is provided with a main graphic display means adapted to the playing of said base game.

Preferably said at least one electronic gaming machine is provided with a secondary graphic display means adapted to display indicia associated with said range of potential jackpot prizes.

Preferably said secondary display means comprises a segment of said main graphic display means.

Preferably said segment is displayed continuously while said electronic gaming machine is in use.

Preferably said segment is displayed intermittently between successive plays of said base game.

Preferably said secondary graphic display means is a separate secondary graphic display mounted to each of said at least one electronic gaming machine.

Preferably said graphic display means is cathode ray tube.

Preferably said graphic display means is a liquid crystal display.

Preferably said graphic display means is a plasma screen.

Preferably said graphic display means is a back projection system.

Preferably volume of play of said base game provides an input so as to incrementally increase values of said at least one jackpot prize.

Preferably said at least one electronic gaming machine is one of a plurality of gaming machines; each of said gaming machines linked to a site control module.

Preferably said secondary displays of each one of said plurality of gaming machines are mounted in a common enclosure; said closure superposed over said plurality of gaming machines.

Preferably said secondary displays are arranged in an abutting array so as to permit a progressive display of graphics from any one display to other ones of said abutting array.

Preferably said site control module maintains soft meters for each one of said plurality of gaming machines; said soft meters maintaining current accumulated turnover values generated by each of said machines.

Preferably each one of said plurality of gaming machines is provided with a machine processor.

Preferably each one of said plurality of gaming machines is provided with a graphic display controller.

Preferably each one of said plurality of gaming machines is provided with a progressive control module.

Preferably each said progressive control module is adapted to convert said current accumulated turnover into a corresponding number of bonus games.

Preferably each said progressive control module is adapted to convert said current accumulated turnover into a corresponding identifier of an item of perceived value.

Preferably indicia indicating said number of bonus games is displayed on said secondary graphic display means.

Preferably graphic imagery of said item of perceived value is displayed on said secondary graphic display means.

Preferably said site controller supports three levels of jackpot prizes.

Preferably each level of said three levels of jackpot prizes is defined by a predetermined range of bonus games.

Preferably each level of said three levels of jackpot prizes is defined by a predetermined range of items of perceived value.

Preferably said machine processor signals said progressive controller of any jackpot winning event of a base game play.

Preferably said progressive controller signals said site controller of said jackpot winning event; said signal including said level of jackpot prize.

Preferably said site controller transmits current accumulated turnover value to said progressive control module.

Preferably said progressive control module enables play of said bonus games.

In yet a further broad form of the invention there is provided a method of play as herein described and with reference to the accompanying drawings.

In yet a further broad form of the invention there is provided apparatus for the playing of games of chance as herein described and with reference to the accompanying drawings.

### BRIEF DESCRIPTION OF DRAWINGS

Embodiments of the present invention will now be described with reference to the accompanying drawings wherein:

FIG. 1 is a front view of a stand-alone gaming machine having a single graphic display according to a first preferred embodiment of the invention.

FIG. 2 is a front view of a stand-alone gaming machine provided with an additional graphic display according to a second preferred embodiment of the invention.

FIG. 3 is a front view of a number of linked gaming machines each with a single graphic display according to a third preferred embodiment of the invention.

FIG. 4 is a front view of a number of linked gaming machines each provided with an additional graphic display housed in a top box mounted to the top of each gaming machine.

FIG. 5 is a front view of a number of linked gaming machines each provided with an additional graphic display housed in a common enclosure according to a fifth preferred embodiment of the invention.

FIG. 6 is a front view of a number of linked gaming machines supporting a common enclosure housing graphic displays for each machine; the graphic displays close-coupled together to permit graphic imagery to flow across multiple screens.

FIG. 7 is a flow diagram showing the interaction between one of a linked plurality of gaming machines, a site controller and a graphical display.

FIG. 8 is a flow diagram showing the interaction of FIG. 7 after the winning of a jackpot prize.

### DETAILED DESCRIPTION OF PREFERRED EMBODIMENTS

It is an object of the present invention to offer increased interest in the playing of gaming machines by the conferring of non-monetary prizes as jackpot prizes. Non-monetary prizes according to at least some preferred embodiments of the invention may consist of bonus games or items of perceived value, or a combination of these. Items of perceived value may range for example from small appliances through major household goods, holiday travel and accommodation to cars and so forth.

### First Preferred Embodiment—Stand-Alone Machine

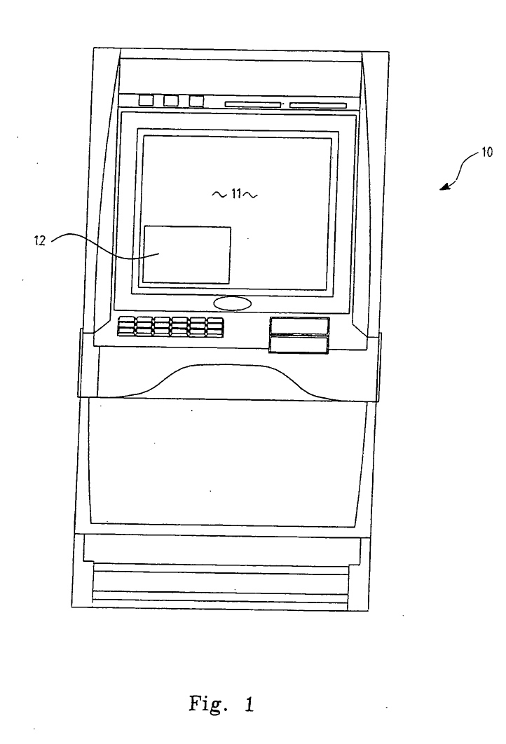

A first preferred embodiment of the invention will now be described with reference to FIG. 1 in which a stand-alone electronic gaming machine 10 is provided with a single graphic display screen 11, either in the form of a cathode ray tube (CRT) or liquid crystal display (LCD), plasma display or back projection system, for the playing of any of one or more base games offered by the machine. Indicia indicating at least one jackpot prize to be won may be displayed on a segment 12 of the main graphic display. This segment 12 may be visible at all times or only intermittently, such as for example between successive plays of a main game. The conferring of any jackpot prize is dependent on predetermined outcomes of a base game.

In at least some forms of this embodiment of the invention, more than one jackpot level may be offered. Thus for example three levels of jackpot may be offered in the form of multiples of bonus games or other non-monetary prizes as outlined above. In this particular example, the first jackpot level being the lowest in value may indicate a number of bonus games incrementing between a minimum number of games and a maximum as play proceeds on the base game. The second jackpot level may then for example be dedicated to a range of items of perceived value with the top level of jackpot reserved for major non-monetary prizes. Each jackpot level may be triggered by at least one winning outcome of the main game. This outcome, or these outcomes may also be displayed in the jackpot segment 12 of the main screen 11.

Where the jackpot win offers a number of bonus games, these may be offered as free plays of the base game or may be offered in the form of special bonus games. Bonus games may be arranged with their own system of conferring prizes. Where bonus games are free plays of the main game they will offer additional opportunities to win payouts associated with the main game. Alternatively, bonus games may offer potential wins in the higher levels of the non-monetary prizes.

Base game outcomes may be of the so-called symbol-driven type wherein a base game consisting of a plurality of spinning wheels with indicia arranged peripherally are sequentially arrested indicate a winning combination of indicia. Alternatively the trigger for a jackpot win may occur according to the so-called random mystery method.

Preferably in at least some forms of the present embodiment, a jackpot value may increase incrementally as a function of the volume of play or turnover preceding the triggering of a jackpot through a winning outcome of the base game. Such incrementing of a jackpot value may apply to both bonus game type jackpot prizes and items of perceived value Jackpots. Thus in the case of items of perceived value jackpots, by way of example, a jackpot may have a base prize consisting of a small domestic appliance such as a toaster, but may progress through a microwave, a stereo system to a washing machine and so forth. With each incrementing of the jackpot, the new prize, be it in the form of bonus games or a higher level of item of perceived value, will be displayed to the player of the base game in the jackpot screen segment.

### Second Preferred Embodiment—Stand-Alone Machine with Top-Box Graphic Display

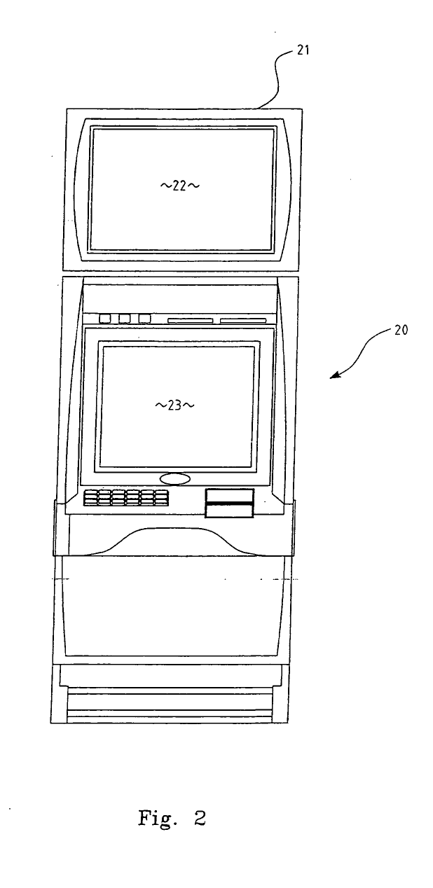

In a second preferred embodiment of the invention with reference to FIG. 2, a stand a one electronic gaming machine 20 is provided with a top box 21 containing a secondary graphic display 22 in addition to the main or primary screen 23 of the gaming machine. This secondary graphic display also may be either in the form of a cathode ray tube (CRT), liquid crystal display (LCD), plasma display or back projection system. In this embodiment the primary display is devoted to the playing of a base game while the top box secondary graphic display is devoted to matters relating to the non-monetary jackpot or jackpots. Thus the secondary graphic display may indicate the jackpot/s offered including the current value or values. Bonus games where offered by a jackpot may also be played on the secondary graphic display under the control of the machine's processor.

While a machine is unattended by a player, the secondary graphic display may alternate between the jackpot/s value display and attractor images and/or animations, such as for example showing a sequence of images of the items of perceived value which may be won or the range of bonus games.

As in the first preferred embodiment described above, in at least one preferred form of this embodiment also, the value of any jackpot may increase incrementally between a base value and a maximum value as a function of the volume of play of the base game.

### Third Preferred Embodiment—Linked Machines

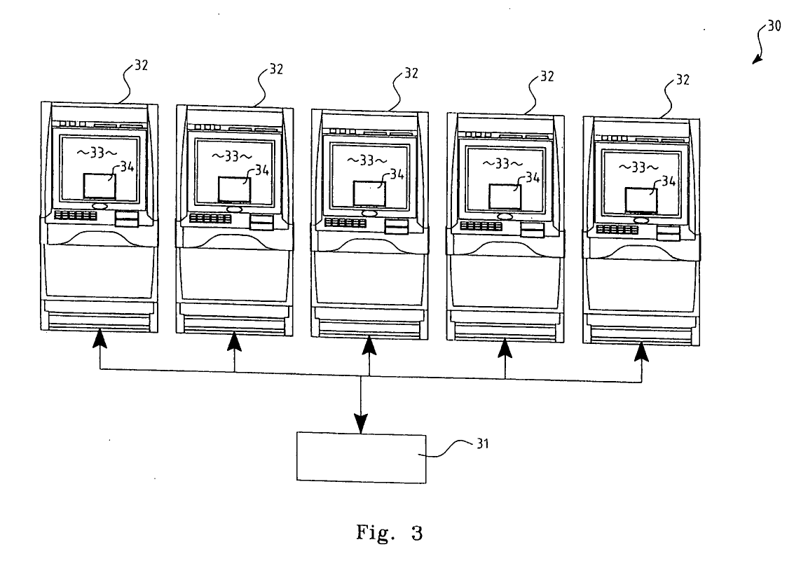

With reference to FIG. 3 in a third preferred embodiment of the invention a number of electronic gaming machines 30 may be interlinked by means of site control module 31. In this embodiment each machine 32 is provided with a single main graphic display 33 for playing the base game offered on the machines with provision for a segment 34 of the graphic display to provide a player of the machine with information of possible jackpot/s as described in the first preferred embodiment above.

In this embodiment also the jackpot prizes may be in the form of bonus games or other non-monetary prizes and with the number of bonus games and items of perceived value prizes incrementing in number and value between predetermined minimum and maximum values. However in this embodiment it is the aggregate value of play on the linked machines which determines the incrementing of the value of the jackpot prizes. Each player on an active machine will be made aware of the jackpot values, either by a continual display in the segment of the main graphic display or intermittently between plays of the base game on each machine.

When the outcome of a base game on a particular machine triggers a win of one of the jackpot prizes, all players on the remaining machines will be alerted to the win by suitable displays on their jackpot display screen segment.

During play of base games on the linked machines, the site control module receives turn-over data from each machine and continually transmits updated aggregated turn-over values back to the individual game control processor of each machine. At each sufficient increase in this value, each machine control processor converts the new aggregated turn-over value either into an incremented number of bonus games for a bonus game jackpot, or into a display of the next item in the sequence of items of perceived value.

In at least one preferred form of this embodiment the probability of winning a jackpot non-monetary prize may be biased towards the machine with the highest accrued turnover.

When a jackpot triggering outcome occurs as a result of play of a base game on a particular machine that machine notifies the site controller of the “hit”. The controller acknowledges the hit event and resets the aggregated turn-over value back to a base level from where it again begins to accumulate as base games continue to be played.

Where the jackpot won confers a number of bonus games, the winning machine's processor sets the main graphic display to progressively allow play of the bonus games.

### Fourth Preferred Embodiment—Linked Machines with Individual Top-Boxes

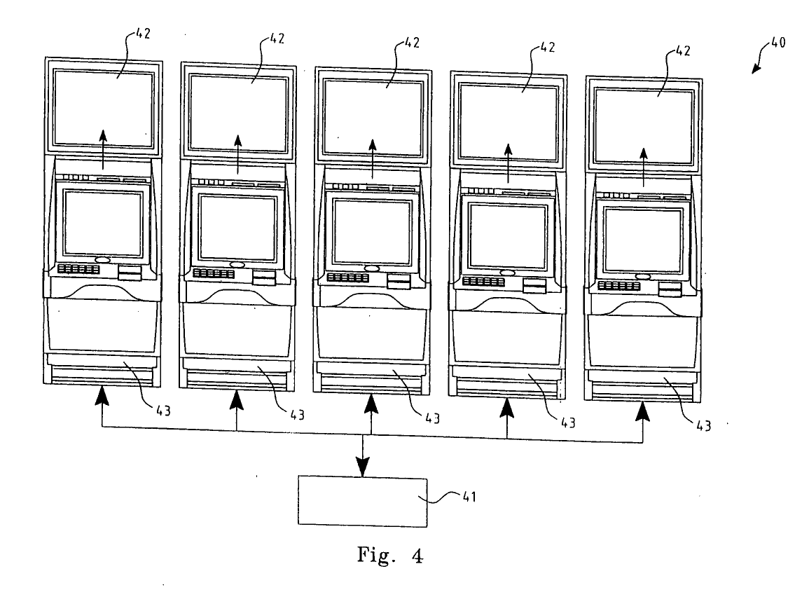

In this preferred embodiment as shown in FIG. 4 a group of machines 40 is linked to a site control module 41 in the manner described in the third preferred embodiment and the process of jackpot display, incrementing of jackpot values, and the triggering of a jackpot remain the same. However the jackpot value displays, playing of bonus games and the display of any associated attracting images or animations are in this embodiment displayed in a separate secondary graphic display 42 in the top box of each machine 43.

### Fifth Preferred Embodiment—Linked Machines with Common Top-Box, Individual Graphic Display Modules

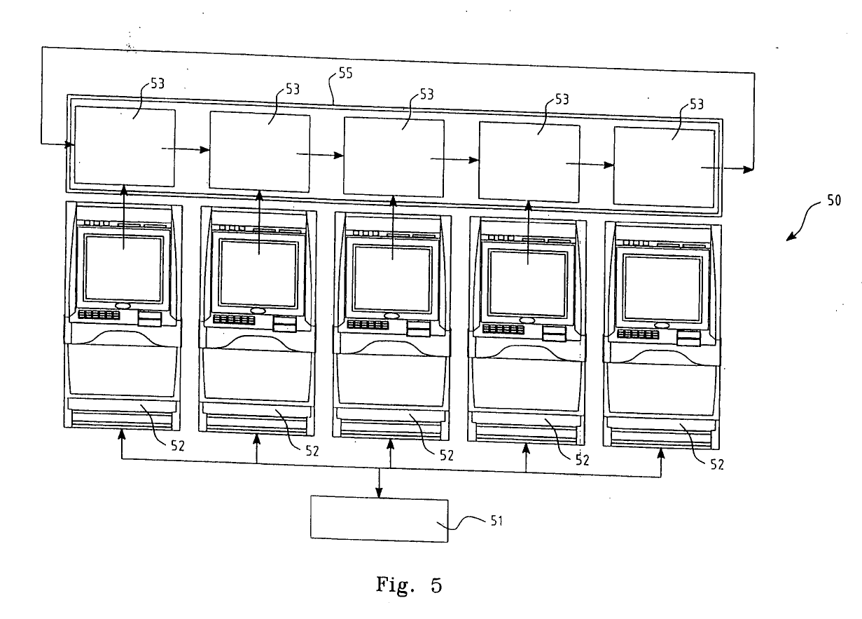

In a fifth preferred embodiment of the invention as shown in FIG. 5, all aspects of the interaction of a site controller 51 with individual machines 52, the playing of games and the display of jackpot related material remains the same as for the fourth embodiment described above, but in this embodiment the secondary graphic display 53 for each machine 52 is accommodated in a common top-box 55 mounted across the top of the group of machines 50.

As well, in at least one form of the present embodiment the imagery shown in each secondary graphic display 53 may act cooperatively under the control of a particular machine when that machine achieves a jackpot triggering outcome. This may take the form of an animation sequence for example drawing the attention of the other players of machines in the group to the winning machine and the nature of the jackpot prize won.

### Specific Example of a Preferred Embodiment

### Overview

This preferred embodiment comprises a 3 level progressive link where bonus games or other non-monetary prizes are awarded to a player and where progressive link triggering is based on predetermined winning combinations of a main game.

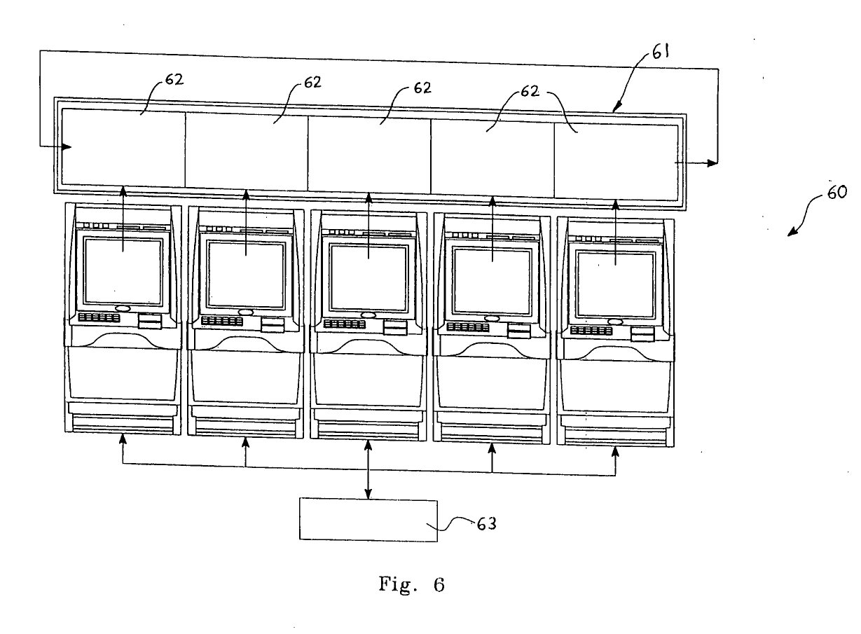

The link consists of a plurality of electronic gaming machines provided with a large common top box, mounted on top of the machines. FIG. 6 shows a particular example of this embodiment in which five machines 60 share common top box 61 and are linked to a site controller 63. The top box 61 contains 5 secondary graphic displays 62 each controlled by a graphic display controller module (GDCM). The secondary graphic displays may be in the form of a cathode ray tube (CRT), a liquid crystal display (LCD), a plasma screens or a back projection system for example. The secondary graphic displays 62 are used to display the potential jackpots to be won in each of the three levels, thus the current progressive bonus games amount/s and the higher levels of non-monetary prizes. The secondary graphic displays will also indicate the winning of a jackpot, what that win is, and allow the playing of bonus game/s. During periods of non-play on a machine the display shows attraction animations, etc.

In at least one preferred form of this embodiment as illustrated in FIG. 6, the secondary graphic displays 62 are mounted in close coupled format without Individual surround framing so as to allow a continuous graphic image flow across any combination of the displays.

### Software

### Link Overview

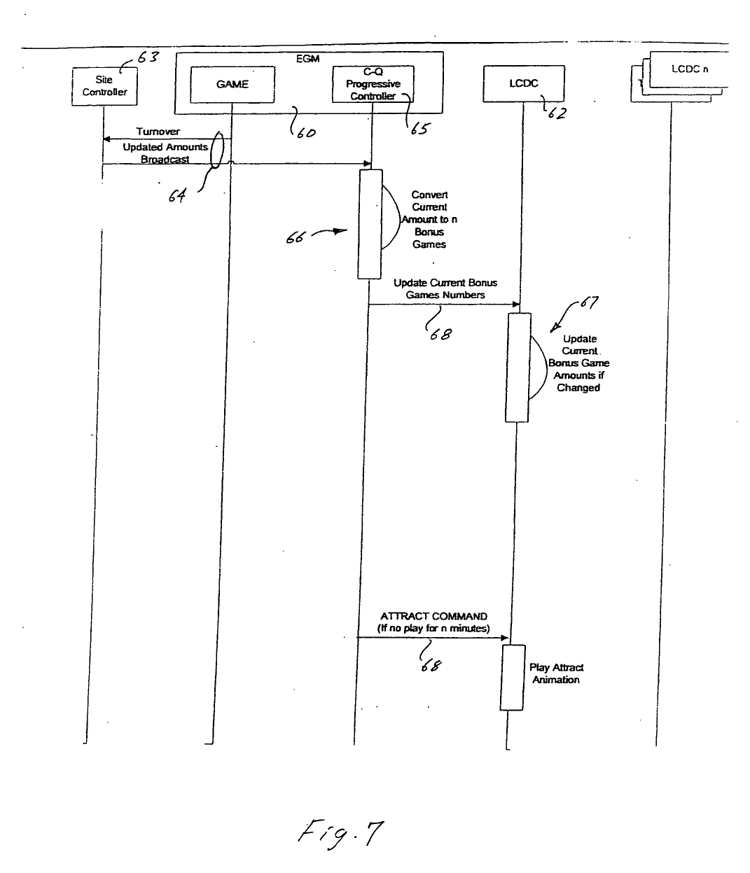

FIG. 7 which shows a flow diagram of the interaction between one of the five gaming machines 60 with the site controller-63 which maintains soft meters for each machine. The base game being played on the machine 60 transmits turnover amounts to the site controller 63 via an Rs232 serial link 64. Communication between the game processor, progressive controller module 65 and the site controller 63 is via a suitable protocol, such as for example the QCOM protocol. The current updated amount, is transmitted via the link 64 to the gaming machine progressive control module 65 and converted into bonus games 66 (or into references for particular items of perceived value). The bonus games are then transferred to a graphic display bonus meter 67 via a 2-way Rs422 link 68 between the machine processor and the graphic display controller. In the case of an item of perceived value jackpot the reference is used to display an image of the item.

The site controller supports 3 levels of jackpot with each level defined by a predetermined range of bonus games or range of items of perceived value, calculated on sliding scales according to turnover value.

The triggering of a jackpot is by a winning combination in the base came. There may be more than one winning combination for each jackpot level. When a jackpot-winning combination is hit in the base game the site controller is notified by the machine processor. Confirmation from the site controller (i.e The Linked Progressive Award Acknowledged poll) is then transmitted to the progressive controller module of the machine.

### Jackpot Conversions

The basic premise of the link is that for bonus game jackpots, progressive amounts are converted into a number of bonus games which are played in the secondary graphic display. Normal game play will still be available while a bonus game is being played.

The monetary value of the progressive amount is treated as the average prize paid for a number of bonus or free games. For example, if for 10 free games the average amount won is $20, and if the site controller is configured as “Start Up”=$20, with a “Limit”=$50 the conversion table would look like:

| | No Of |
|---|---|
| $ Value | Games |
| $20 | 10 |
| $23 | 11 |
| $26 | 12 |
| $29 | 13 |
| $32 | 14 |
| $35 | 15 |
| $38 | 16 |
| $41 | 17 |
| $44 | 18 |
| $47 | 19 |
| $50 | 20 |

When the broadcast progressive values are received they are converted by the progressive controller module to the calculated number of games and this number is then used for displaying current bonus game meters in the secondary graphic display of the top box as well as playing the actual number of bonus games.

Similar conversion tables may be constructed for items of perceived value jackpots. The progressive controller module in this case converts the progressive values of current turnover value received from the site controller into a corresponding reference to an item of perceived value and causes the secondary graphic display to show images of that item.

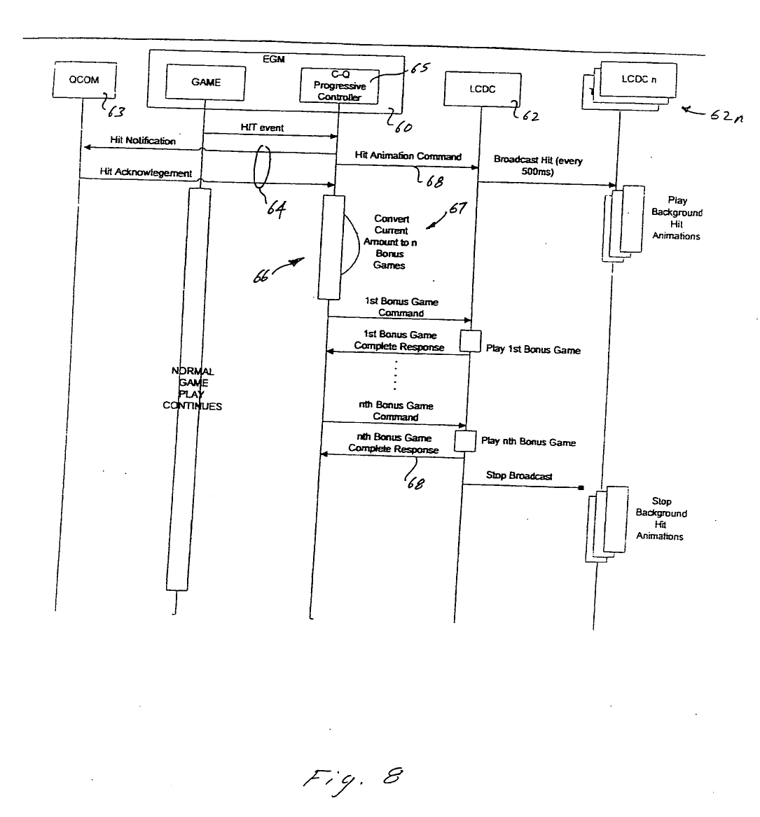

FIG. 8 is a flow diagram of the sequence of events attending the triggering of a jackpot by one of the gaming machines 60. A hit event signal is then firstly transmitted to the progressive control module 65 which firstly notifies the site controller 63 of the hit and the level or the triggering combination. It then activates a hit animation via link 68 for display on the secondary graphic display 62 of the winning machine 60 and may also cause appropriate animations to be displayed on the other machines 62n in the group of five.

The site controller 63 acknowledges the hit and transmits the turnover value amount as recorded by it at the hit event. The progressive controller module 65 converts this value into the appropriate number of bonus games (or causes the graphic display to indicate an item of perceived value jackpot which may be claimed by the player).

Bonus game play is enabled by the progressive controller module 65 and the player sequentially plays these. During this interval the hit animation may continue to be shown on the winning machine secondary graphic display and optionally on the other machine displays as well. When the sequence of bonus game play is completed, the animations are terminated and the displays will revert to show either accumulating bonus game or other non-monetary prize indications.

The site controller is notified by the progressive controller module that the bonus game sequence is complete thus resetting the meter for that machine.

### Graphic Display Controller (GDC)

The GDC is completely controlled from the gaming machine software, as the GDC has no backup ram.

It is controlled via a 2-way Rs422 link between the gaming machine and graphic display-using a similar protocol to the “WildFire” progressive game protocol currently used in QLD and NSW.

The secondary graphic display is used for displaying:

1. The three current potential jackpot prizes,

2. Bonus Game Play; reel stops sent from the gaming machine,

3. Jackpot Hit Animations; played when jackpot is triggered,

4. Idle Attraction animations—displayed during no action from the gaming machine.

The facility for synchronising hit animations flowing across adjoining graphic display screens is achieved using a simple 1 way serial link between the graphic display controllers. When a GDC receives a HIT command poll from its gaming machine it will send out a HIT poll to the graphic display screen, which will then display the HIT animation.

The above describes only some embodiments of the present invention and modifications, obvious to those skilled in the art, can be made thereto without departing from the scope and spirit of the present invention.

1. A method of play on an electronic gaming machine wherein at least one predefined outcome of a base game played on said gaming machine triggers the winning of at least one jackpot prize from a range of potential jackpot prizes; said range of potential jackpot prizes being non-monetary prizes.

2. The method of claim 1 wherein said non-monetary prizes are bonus games.

3. The method of claim 1 wherein said non-monetary prizes are items of perceived value.

4. The method of claim 1 wherein said non-monetary prizes are combinations of bonus games and at least one item of perceived value.

5. The method of claim 1 wherein indicia relating to said potential jackpot prizes is displayed on a segment of a single graphic display screen of said electronic gaming machine.

6. The method of claim 1 wherein indicia relating to said potential jackpot prizes is displayed on a secondary graphic display screen of said electronic gaming machine.

7. The method of claim 6 wherein said graphic display screen is a cathode ray tube.

8. Apparatus for the playing of a games of chance wherein the outcome of a base game played on said apparatus triggers the winning of at least one jackpot prize from a range of potential jackpot prizes; said range of potential jackpot prizes being non-monetary prizes.

9. The apparatus of claim 8 wherein said non-monetary prizes are bonus games.

10. The apparatus of claim 8 wherein said non-monetary prizes are items of perceived value.

11. The apparatus of claim 8 wherein said non-monetary prizes are combinations of bonus games and at least one item of perceived value.

12. The apparatus of any one of claim 8 wherein said apparatus includes at least one electronic gaming machine.

13. The apparatus of claim 12 wherein said at least one electronic gaming machine is provided with a main graphic display means adapted to the playing of said base game.

14. The apparatus of any one of claim 8 wherein said at least one electronic gaming machine is provided with a secondary graphic display means adapted to display indicia associated with said range of potential jackpot prizes.

15. The apparatus of claim 14 wherein said secondary display means comprises a segment of said main graphic display means.
